(19) United States
(12) Patent Application Publication
(10) Pub. No.: US 2020/0209828 A1
(43) Pub. Date: Jul. 2, 2020

(54) METHOD FOR MONITORING AN AUTOMATION SYSTEM

(71) Applicant: Endress+Hauser Process Solutions AG, Reinach (CH)

(72) Inventor: Matthias Altendorf, Lörrach (DE)

(21) Appl. No.: 16/632,465

(22) PCT Filed: Jun. 20, 2018
(86) PCT No.: PCT/EP2018/066379

§ 371 Date: Jan. 20, 2020

(30) Foreign Application Priority Data
Jul. 18, 2017 (DE) 10 2017 116 167.8

(51) Int. Cl. G05B 19/406; G05B 23/02

(52) U.S. Cl. CPC G05B 19/406; G05B 2219/31483; G05B 2219/25428; G05B 23/0235

(57) ABSTRACT

The present disclosure includes a method for monitoring an automation system having a multiplicity of field devices arranged in a spatially distributed fashion and configured to acquire or set a primary process variable that is dependent on the process. The field devices are also configured to each acquire at least one secondary environmental variable and have at least one superordinate process control unit for controlling the process. The method includes transmitting the acquired environmental variables to a superordinate database and analysis platform and monitoring the automation system using the database and analysis platform. To monitor the automation system, the database and analysis platform compares the acquired transmitted secondary environmental variables with comparative environmental variables which represent a usual state of the automation system, in order to detect an unusual state in the automation system.

The invention relates to a method for monitoring an automation system, to an automation technology field device and to an automation technology system.

In automation technology, especially, in process automation technology, field devices serving to acquire and/or modify process variables are frequently used in so-called automation systems. Sensors, such as fill level measuring devices, flow meters, pressure and temperature measuring devices, pH-redox potential meters, conductivity meters, etc., are used for recording the respective process variables, such as fill level, flow, pressure, temperature, pH level, and conductivity. Actuators, such as drives, aggregates, valves, pumps, via which the flow of a fluid in a pipeline or the fill level in a tank can be altered are used to influence process variables.

Furthermore, in the present case, field devices are also to be understood as so-called analyzers, which are based on Raman spectroscopy, tunable diode laser technology or other optical methods, for example near-infrared or UV technology. Furthermore, wet chemical analyzers can also be used as field devices.

The sensor can, for example, be a pH sensor, a redox potential or ISFET sensor, a temperature sensor, a conductivity sensor, a pressure sensor, an oxygen sensor, especially, a dissolved oxygen sensor, or a carbon dioxide sensor; an ion-selective sensor; an optical sensor, especially, a turbidity sensor, a sensor for optical determination of oxygen concentration or a sensor for determining the number of cells and cell structures; a sensor for monitoring certain organic or metallic compounds; a sensor for determining a concentration of a chemical substance, e.g., a certain element or a certain compound; or a biosensor, e.g., a glucose sensor.

These are, in particular, pH, redox potential, temperature, conductivity, pressure, flow, fill level, density, viscosity, oxygen, carbon dioxide or turbidity sensors.

Field devices, in general, refer to all devices which are used in a process-oriented manner and which supply or process process-relevant information, that is, substantially process measured values or process control values. In addition to the aforementioned sensors and actuators, units that are directly connected to a field bus and used for communication with superordinate units, such as remote I/Os, gateways, linking devices, and wireless adapters, are also generally referred to as field devices.

The Endress+Hauser Group develops, produces and distributes a large variety of such field devices.

As already mentioned, such field devices are used in automation systems which perform a process substantially autonomously over a long period of time. In order for the automation system to execute or control the process as optimally as possible, it is necessary for the entire system to be serviced and/or maintained regularly by the system operator's skilled personnel. Particularly in the case of systems which carry out or run a process with inflammatory and/or explosive substances, regular monitoring and/or maintenance is an indispensable requirement.

The regular servicing and/or maintenance involved include, inter alia, the system operator's skilled personnel inspecting the automation system at regular intervals in order to search for possible irregularities, such as a leaking pipe section. Since the automation systems are generally distributed over a relatively wide area, this measure is very complex.

It is thus an object of the invention to demonstrate a possibility with which the monitoring of an automation system can be simplified.

The object is achieved by a method for monitoring an automation technology automation system, an automation technology field device and an automation technology system.

With regard to the method, the object is achieved by a method for monitoring an automation technology automation system which is configured to carry out a process, the automation system comprising at least the following:
a multiplicity of field devices arranged in a spatially distributed fashion in the automation system, each configured to acquire and/or to set a primary process variable that is dependent on the process, the field devices being further configured to each acquire at least one secondary environmental variable,
at least one superordinate process control unit for controlling the process, the process control unit for controlling the process being in data communication with the multiplicity of field devices in such a way that at least the primary process variable can be communicated between the process control unit and the multiplicity of field devices in order to thus control the process,
   wherein the method involves at least the following steps:
transmitting the acquired environmental variables, wherein at least from parts of the multiplicity of field devices, the acquired environmental variable is transmitted to a superordinate database and analysis platform, especially, a cloud-computing-based platform;
monitoring the automation system by means of the database and analysis platform, wherein in order to monitor the automation system, the database and analysis platform compares the acquired transmitted secondary environmental variables with comparative environmental variables which represent a usual state of the automation system in order thereby to detect an unusual state in the automation system.

According to the invention, it is proposed to equip the automation system with field devices which, on the one hand, pursue their actual purpose, the acquiring and/or setting of the process, as a function of a primary process variable, and on the other hand are designed to acquire a secondary environmental variable that is substantially independent of the primary process variable, i.e., it does not relate to a measured value and/or control value of the field device for controlling/setting the process. Because the field devices are spatially distributed in the automation system, a spatially distributed sensor array is obtained which, in addition to the actual primary process variable in the form of a measured value or control value, also acquires the secondary environmental variable. According to the invention, the secondary environmental variable acquired by the respective field devices is transmitted to a superordinate database and analysis platform, which is preferably a cloud-computing-based platform.

For the purposes of the present invention, a cloud-computing-based platform is a database which can be contacted by a user via the Internet. In this case, it can be provided that the database has an application, for example for visualizing the data, stored in the database. A user can access the database application and thus the data via the Internet from his device, for example a PC or a mobile terminal, and have the data displayed on his device in a visualized form.

Furthermore, within the meaning of the present invention, the superordinate database and analysis platform or the cloud-computing-based platform is configured to carry out an analysis on the basis of the acquired and transmitted secondary environmental variable. For this purpose, the cloud-computing-based platform compares the secondary environmental variables acquired and transmitted by the field devices with comparative environmental variables, which represent a usual state of the automation system, in order to thus detect an unusual state in the automation system. The unusual state can subsequently be made available via the Internet on a device of an operator, for example a service technician or maintenance personnel, by means of the database and analysis platform. For example, the unusual state can be visualized on the device of the operator together with the automation system.

In order to reduce the data throughput, an advantageous embodiment of the invention provides that the acquired environmental variables are transmitted with an information density, and in the event that the unusual state is detected, the information density is increased. Especially, the embodiment can provide that the information density is increased by increasing or enhancing a transmission frequency with which the acquired environmental variables are transmitted to the superordinate database and analysis platform. For example, the embodiment may provide for the environmental variables to be transmitted at a first frequency until an unusual state is recognized, and for the environmental variables to be subsequently transmitted at a second frequency that is greater than the first frequency. Alternatively or additionally, the embodiment may provide for the information density to be increased by transmitting the acquired environmental variables from further parts of the multiplicity of field devices to the database and analysis platform. This means that acquired secondary environmental variables of field devices, from which the environmental variables have not yet been transmitted to the superordinate database and analysis platform, are also transmitted.

A further advantageous embodiment of the invention provides that the database and analysis platform at least for parts of the field devices is provided with a field-device-specific comparative variable, especially, field-device-specific comparative calibration and/or start-up variables, which for each corresponding field device specifically maps the secondary environmental variable under standard conditions, and wherein the field-device-specific comparative variables are used by the database and analysis platform to compare the acquired secondary environmental variables with comparative environmental variables. Especially, the embodiment can provide that the field-device-specific comparative variable are generated in that secondary environmental variables are acquired by the corresponding field device when the automation system is started up and/or when the corresponding field device is calibrated.

A further advantageous embodiment of the invention in turn provides that in the event that the unusual state is detected, a location where the unusual state occurs is spatially or geographically isolated in the automation system. In this way, it is possible for the user to have the location where the unusual state occurs presented on his device.

A further advantageous embodiment of the invention provides that a TAG number or measuring point identification number is assigned to the multiplicity of field devices arranged in a distributed fashion and an assignment of the respective field device to the respective TAG number or measuring point identification number is provided to the database and analysis platform. Especially, the embodiment can provide that, on the basis of the assignment of the respective field device to the respective TAG number, the location where the unusual state occurs is spatially or geographically isolated in the automation system.

A further advantageous embodiment of the invention provides for the information density to be increased on the basis of the respective field device with respect to the respective TAG number and the spatial or geographic isolation of the location where the unusual state occurs, especially, the information density to be increased by transmitting the acquired environmental variables from further parts of the field devices located within the isolated location to the database and analysis platform.

An advantageous embodiment of the invention in turn provides that, in the event that the unusual state is detected, the unusual state is evaluated, especially, by assigning a priority to the unusual state.

A further advantageous embodiment of the invention in turn provides that the database and analysis platform is self-learning, which, especially, on the basis of operator inputs which verify or falsify a detected unusual state, learns whether a currently detected unusual state will also be handled as an unusual state in the future.

A further advantageous embodiment of the invention provides that the secondary environmental variable is acquired by the respective field device in the form of a temperature variable, a gas composition, image information, or a vibration variable.

As far as the field device is concerned, the object is achieved by an automation technology field device that comprises at least the following:
at least one sensor element or control element configured to acquire and/or set a process-dependent primary process variable;
at least one environmental sensor element configured to acquire a secondary environmental variable; and
a field device electronic unit configured to receive the primary process variable from a superordinate process control unit and/or to send it to the process control unit and further configured to send the secondary environmental variable to a superordinate database and analysis platform, especially, a cloud-computing-based platform.

An advantageous embodiment of the field device according to the invention provides that the environmental sensor element is configured to acquire a temperature variable, a gas composition, image information, or a vibration variable.

A further advantageous embodiment of the field device in turn provides that the environmental sensor element has a position sensor, especially, a gyro sensor, for acquiring a vibration variable as an environmental variable.

A further advantageous embodiment of the field device in turn provides that the field device electronic unit is also configured to send the secondary environmental variable wirelessly to a superordinate database and analysis platform.

A further advantageous embodiment of the field device provides that the field device electronic unit is further configured to be able to transmit or to transmit the environmental variable at different transmission frequencies.

A further advantageous embodiment of the field device also has a GPS sensor element for determining a spatial or geographic position of the field device.

As far as the system is concerned, the object is achieved by an automation technology system that comprises at least the following:
a multiplicity of field devices arranged in a spatially distributed fashion in an automation system, each of which is designed according to at least one of the previously described embodiments,
at least one superordinate process control unit for controlling the process, which is in data communication with the multiplicity of field devices in such a way that at least the primary process variable can be communicated between the process control unit and the multiplicity of field devices so that a process running in the automation system can be controlled by the process control unit,
a database and analysis platform, especially, a cloud-computing-based platform, which is in data communication with the multiplicity of field devices in such a way that the acquired environmental variables can be communicated from the multiplicity of field devices to the database and analysis platform, and the database and analysis platform is configured to compare the acquired transmitted secondary environmental variables with comparative environmental variables which represent a usual state of the automation system, in order thereby to detect an unusual state in the automation system.

The invention is explained in more detail based upon the following drawings. These show:

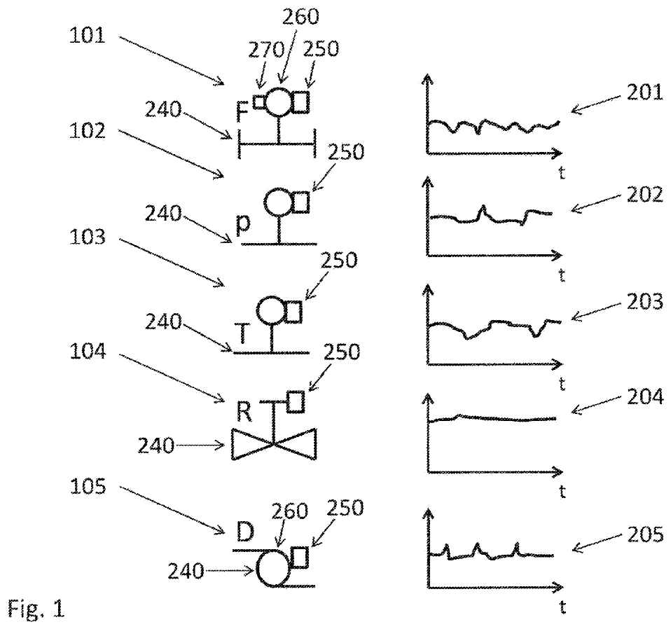

FIG. 1: a schematic representation of a multiplicity of field devices each having an exemplary signal profile of the secondary environmental variable acquired by the corresponding field device,

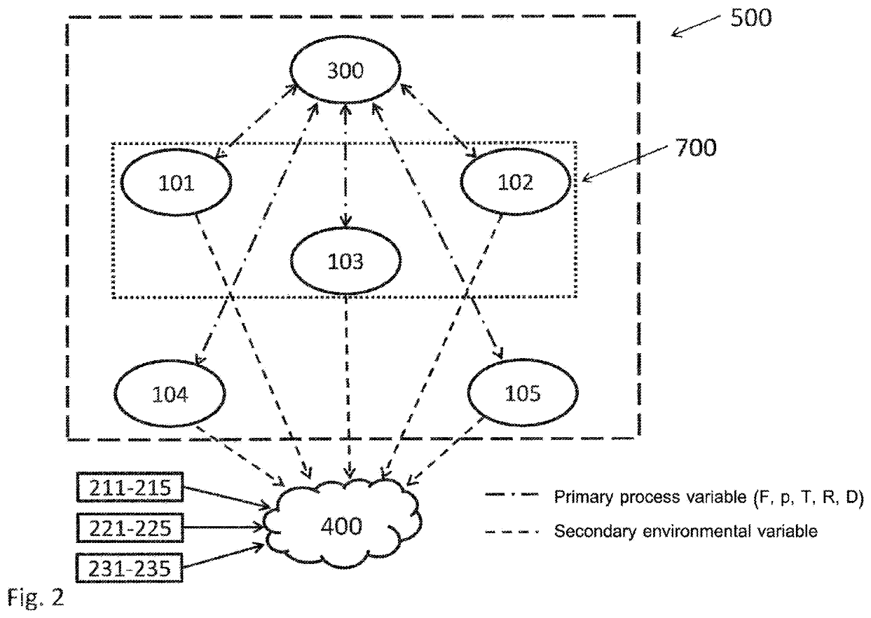

FIG. 2: a schematic representation of an automation technology system comprising an automation system with five field devices arranged spatially differently from one another as well as a database and analysis platform which is arranged outside the automation system in the example shown, and

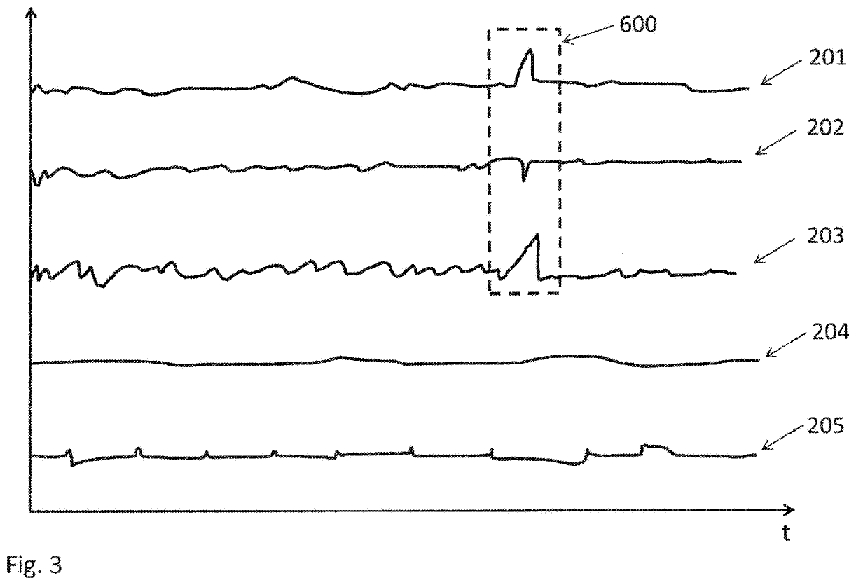

FIG. 3: five exemplary signal profiles of the secondary environmental variable, each of which was acquired by a field device of the automation system shown in FIG. 2 and transmitted to a database and analysis platform for monitoring the system.

FIG. 1 shows a schematic representation of a multiplicity of field devices 101-105 according to the invention and, arranged next to the field devices in each case, an exemplary signal profile of the secondary environmental variables 201-205 acquired by the respective field device 101-105. All field devices 101-105 are designed in such a way that each of them has at least one sensor element or control element 240 which is configured to acquire or set a process variable F, p, T, R and D that is dependent on the process. In this case, a primary process variable F, p, T, R, D dependent on the process is a variable which is used by a superordinate unit 300, for example a memory-programmable logic controller, SPS for short, to control a process to be performed in an automation system 500 in which the field devices 101-105 are arranged. For this purpose, five field devices 101, 102, 103, 104 and 105 are shown as examples in FIG. 1, each of which is configured to acquire or to set a respective different process variable.

This is indicated in FIG. 1 by the symbols “F”, “p”, “T”, “R” and “D”, wherein the symbol “F” is intended to demonstrate that the field device 101 acquires a flow of a medium as the process variable dependent on the process, the symbol “p” that the field device 102 acquires a pressure of the medium as the process variable dependent on the process, the symbol “T” that the field device 103 acquires a temperature of the medium as the process variable dependent on the process, the symbol “R” that the field device 104 controls or sets a flow of the medium as process variable dependent on the process, and symbol “D” that the field device 105 conveys/drives the medium as process variable dependent on the process controls.

Furthermore, according to the invention, all field devices 101-015 each have at least one environmental sensor element 250, which is configured to acquire a secondary environmental variable 201-205. The secondary environmental variable 201-205 is in this case a variable which is substantially independent of the process, i.e., it is substantially independent of the primary process variable F, p, T, R, D and thus does not relate to a measured value and/or control value for controlling or setting the process. Examples of such secondary environmental variables 201-205 are: a temperature variable of an environmental temperature of the field device or an environmental temperature variable, a gas composition variable of an environmental medium of the field device or an environmental gas composition variable, image information comprising a representation of an environment of the field device, or a vibration variable of a vibration of the field device. With regard to the vibration variable, the field device can be designed in such a way that the environmental sensor element 250 has a position sensor, for example a gyro sensor, for determining the vibration variable.

Furthermore, all field devices 101-105 each have a field device electronic unit 260 which is at least configured to receive the primary process variable F, p, T, R, D from a superordinate process control unit 300 and/or send it to the process control unit 300. In addition, the field device electronic unit 260 is also configured to send the secondary environmental variable 201-205 to a superordinate database and analysis platform 400, for example a cloud-computing-based platform. Especially, the field device electronic unit 260 may be configured such that the secondary environmental variable 201-205 is sent wirelessly to the superordinate database and analysis platform 400. For example, the secondary environmental variables can be transmitted by means of Bluetooth (Low Energy), 6LoWPAN, WirelessHART, 6TiSCH, ISA 100.11a, Zigbee (IP), WIA PA or WIA FA, WLAN or corresponding technologies or corresponding protocols.

In order to keep data throughput as low as possible, the field device electronic unit 260 may furthermore be configured to transmit the secondary environmental variable 201-205 at different transmission frequencies.

In order to determine a spatial or geographic position of the field device 101-105 within the automation system 500, it can also be provided that at least parts of the field devices have a GPS sensor element 270.

FIG. 2 shows a schematic representation of an automation technology system comprising an automation system 500 with five field devices 101-105 arranged spatially differently from one another and a database and analysis platform 400, which is arranged outside the automation system 500 in the example shown. This means that at least parts of the resources of the database and analysis platform 400 are located outside the system 500. Of course, it is also conceivable for the database and analysis platform 400 to be arranged exclusively inside the automation system 500. This means that all the resources of the database and analysis platform 400 are located inside the system 500. The database and analysis platform 400 can be designed in such a way that only a defined user group can or may access it. The defined user group usually comprises users that are to be assigned to the system operator, for example they may be the maintenance personnel of the system operator. As an alternative or in addition thereto, the defined user group may comprise users that cannot be assigned directly to the system operator, for example service technicians of the field device manufacturer.

The field devices 101-105 arranged in a spatially or geographically distributed fashion in the automation system 500 are designed in accordance with the above-described embodiments and transmit the primary process variable F, p, T, R, D to a superordinate process control unit 300 and/or receive the primary process variable F, p, T, R, D therefrom in order to thus control a process running in the system 500. In FIG. 2, the transmission of the primary process variables F, p, T, R and D is exemplarily indicated by dash-dot arrows.

The database and analysis platform 400, which is, for example, a cloud-computing-based platform, is in data communication with the field devices 101-105 in order to thus be able to transmit the secondary environmental variable 201-205. In FIG. 2, the transmission of the secondary environmental variable 201-205 is exemplarily indicated by dashed arrows. For example, the secondary environmental variable 201-205 of the individual field devices 101-105 may be transmitted by one of the previously listed technologies or protocols for wireless data transmission.

The secondary environmental variables 201-205 acquired and transmitted by the field devices 101-105 are used by the database and analysis platform 400 to monitor the automation system 500. For this purpose, the database and analysis platform 400 compares the secondary environmental variables 201-205 with comparative environmental variables 211-215 in order to be able to detect an unusual state 600 in the system 500.

The comparative environmental variables 211-215 represent the environmental variable of the respective field device 101-105 in a usual state and preferably relate to at least one field device of the automation system or a partial area of the automation system or also to an entire automation system. The comparative environmental variables 211-215 are supplied to the database and analysis platform 400, especially, before the actual monitoring. In FIG. 2, this is indicated by solid arrows. For example, at least for parts of the field devices 101-106, the database and analysis platform 400 may be provided with a field-device-specific comparative value 221-225, which for the corresponding field device 101-105 specifically maps the secondary environmental variable 201-205 at standard conditions that represent a usual state of the field devices 101-105. Especially, the field-device-specific comparative calibration and start-up variables relating to the respective field device 101-105 come into question as field-device-specific comparative variable. They can, for example, be acquired by the respective field device 101-105 when the automation system 500 is started up and/or when the corresponding field device 101-105 is calibrated, it being assumed that the conditions during the calibration and start-up of the automation system 500 represent a usual state.

Based on the comparative environmental variables 211-215 supplied to the database and analysis platform 400, said platform analyzes the secondary environmental variables 201-205 received from the field devices 101-105 for an unusual state, wherein provision may be made for the acquired environmental variables 201-205 to be transmitted with an information density and, only in the event that the unusual state 600 is detected, for the information density with which the environmental variables 201-205 were transmitted to date to be increased. This can be done, for example, in such a way that, as long as no unusual state has been detected, environmental variables 201-205 are transmitted to the database and analysis platform not by all field devices 101-105 but only by parts thereof, and in the event that an unusual state 600 is detected, the secondary environmental variables are transmitted by further field devices. For example, in addition to a gas composition variable acquired by a field device as a secondary environmental variable, image information of a further field device, which is preferably located in spatial proximity to the field device, can also be transmitted as a secondary environmental variable. As an alternative or in addition thereto, the information density can also be increased in such a way that the transmission frequency with which the secondary environmental variables 201-205 are transmitted is increased. For example, as long as no unusual state has been detected, the secondary environmental variable 201-205 may be transmitted every minute, and in the event that an unusual state was detected, may be transmitted every second. Increasing or enhancing the information density can serve to verify the unusual state detected.

The database and analysis platform 400 may also be configured to geographically and spatially isolate more specifically the position of a location 700 where the unusual state 600 occurs, after an unusual state 600 was detected. This can be achieved, for example, by assigning a TAG number or measuring point identification number 231-235 to the field devices 101-105 of the automation system and providing said number to the database and analysis platform 400. Today, such a TAG number or measuring point identification number 231-235 is common in automation systems 500 and uniquely identifies each field device 101-105 within the automation system 500 by a multiplicity of information, especially, also the information of an installation location, for example in accordance with DIN EN 61346. By means of such TAG numbers 231-235, the operators of automation systems 500 can, for example, fulfill their legal verification requirements. By providing the database and analysis platform 400 with an assignment to the respective field device 101-105 with respect to the respective TAG number 231-235, the position of the location 700 where the unusual state 600 occurs can be spatially or geographically isolated more specifically in the automation system 500. In FIG. 2, this is exemplarily indicated by a rectangle with a dashed line, which is intended to indicate the location where the unusual state occurs. In addition, the database and analysis platform 400 can also increase the information density on the basis of the TAG number 231-235 by determining by means of the TAG number 231-235 further field devices 101-105 which are located at a spatial distance from the field device 101-105 on which the unusual state was detected and whose acquired secondary environmental variables 201-205 are transmitted. Thus, in order to illustrate this using the example shown in FIG. 2, in the event that an unusual state 600 is detected on the basis of the secondary environmental variable 203 acquired by the field device 103, the database and analysis platform 400 can cause the environmental variables 201 and 202 acquired by the field devices 101 and 102 to be transmitted as well.

As an alternative or in addition thereto, the database and analysis platform 400 can be designed such that the unusual state 600 is evaluated with regard to its extent. For example, in the event that the unusual state 600 is detected, the database and analysis platform 400 may assign a priority to the unusual state 600. In this case, the priority can be identified in a wide variety of ways by the database and analysis platform 400. For example, the unusual states 600 can be identified to a user of the database and analysis platform 400 by means of a color marking that reflects the evaluated priority.

The database and analysis platform 400 may alternatively or additionally also be designed as a self-learning database and analysis platform, i.e., the platform is designed such that it learns independently. For example, the platform may have optimization methods that allow an unusual state 600 to be detected with a higher probability. This can take place in such a way that, in the event of a currently detected unusual state 600, the platform 400 learns, for example, by verifying or falsifying by means of a user input whether the currently detected unusual state 600 will also be detected again as an unusual state 600 in the future.

FIG. 3 shows exemplarily five signal profiles of the secondary environmental variable 201-205, each of which was acquired by a field device 101-105 of the automation system 500 shown in FIG. 2. The environmental variables 201-205 acquired by the field devices 101-105 were transmitted to the database and analysis platform 400 for monitoring the system, which database and analysis platform, upon comparing the secondary environmental variables 201-205 with comparative environmental variables 211-215, detected an unusual state 600 on the basis of the acquired environmental variables 201, 202 and 203.

### LIST OF REFERENCE SYMBOLS

101-105 Automation technology field devices
201-205 Secondary environmental variables
211-215 Comparative environmental variables
221-225 Field-device-specific comparative variable
231-235 TAG number or measuring point identification number
240 Sensor element or control element
250 Environmental sensor element
260 Field-device electronic unit
270 GPS sensor element
300 Superordinate process control unit
400 Database and analysis platform
500 Automation system
600 Unusual state
700 Location where the unusual state occurs
F, p, T, R, D Primary process variable

1-20. (canceled)

21. A method for monitoring an automation technology automation system which is configured to carry out a process, wherein the automation system comprises at least the following:
a multiplicity of field devices arranged in a spatially distributed fashion in the automation system, each field device configured to acquire or to set a primary process variable that is dependent on the process, wherein the field devices are each further configured to acquire at least one secondary environmental variable; and
at least one superordinate process control unit for controlling the process, wherein the process control unit is in data communication with the multiplicity of field devices such that at least the primary process variable can be communicated between the process control unit and the multiplicity of field devices in order to control the process;
wherein the method includes the following steps:
transmitting the acquired environmental variables, wherein at least from parts of the multiplicity of field devices, the acquired environmental variable is transmitted to a superordinate database and analysis platform; and
monitoring the automation system by means of the database and analysis platform, wherein in order to monitor the automation system, the database and analysis platform compares the acquired transmitted secondary environmental variables with comparative environmental variables which represent a usual state of the automation system, in order thereby to detect an unusual state in the automation system.

22. The method of claim 21, wherein the acquired environmental variables are transmitted with an information density, and, if the unusual state is detected, the information density is increased.

23. The method of claim 22, wherein the information density is increased by increasing or enhancing a transmission frequency with which the acquired environmental variables are transmitted to the superordinate database and analysis platform.

24. The method of claim 22, wherein the information density is increased by transmitting the acquired environmental variables to the database and analysis platform from further parts of the multiplicity of field devices.

25. The method of claim 21, wherein the database and analysis platform is provided with a field-device-specific comparative variable, which for each corresponding field device maps the secondary environmental variable under standard conditions, and wherein the field-device-specific comparative variables are used by the database and analysis platform to compare the acquired secondary environmental variables with comparative environmental variables.

26. The method of claim 25, wherein the field-device-specific comparative variables are generated in that secondary environmental variables are acquired by the corresponding field device when the automation system is started up or when the corresponding field device is calibrated.

27. The method of claim 21, wherein in the event that the unusual state is detected, a location where the unusual state occurs is spatially or geographically isolated in the automation system.

28. The method of claim 22, wherein a TAG number or measuring point identification number is assigned to the multiplicity of field devices arranged in a distributed fashion and an assignment of the respective field device to the respective TAG number or measuring point identification number is provided to the database and analysis platform.

29. The method of claim 28, wherein, based on the respective field device to the respective TAG number, the location where the unusual state occurs is spatially or geographically isolated in the automation system.

30. The method of claim 28, wherein the information density is increased on the basis of the respective field device with respect to the respective TAG number and the spatial or geographic isolation of the location where the unusual state occurs.

31. The method of claim 21, wherein in the event that the unusual state is detected, the unusual state is evaluated and assigned a priority.

32. The method of claim 21, wherein the database and analysis platform is self-learning, and learns whether a currently detected unusual state will also be handled as an unusual state in the future.

33. The method of claim 21, wherein the secondary environmental variable is acquired by the respective field device in the form of a temperature variable, a gas composition, image information, or a vibration variable.

34. An automation technology field device, having:
at least one sensor element or control element configured to acquire or set a primary process variable that is dependent on the process;
at least one environmental sensor element configured to acquire a secondary environmental variable; and
a field device electronic unit configured to receive the primary process variable from a superordinate process control unit or send it to the process control unit, and further configured to send the secondary environmental variable to a superordinate database and analysis platform.

35. The field device of claim 34, wherein the environmental sensor element is configured to acquire a temperature variable, a gas composition, image information, or a vibration variable.

36. The field device of claim 34, wherein the environmental sensor element comprises a position sensor.

37. The field device of claim 34, wherein the field device electronic unit is further configured to wirelessly transmit the secondary environmental variable to the superordinate database and analysis platform.

38. The field device of claim 34, wherein the field device electronic unit is further configured to transmit the environmental variable at different transmission frequencies.

39. The field device of claim 34, further comprising a GPS sensor element for determining a spatial or geographic position of the field device.

40. An automation technology system, including:
a multiplicity of field devices arranged in a spatially distributed fashion in an automation system, each of which includes: at least one sensor element or control element configured to acquire or set a primary process variable that is dependent on a process; at least one environmental sensor element configured to acquire a secondary environmental variable; and a field device electronic unit configured to receive the primary process variable from a superordinate process control unit or send it to the process control unit, and further configured to send the secondary environmental variable to a superordinate database and analysis platform;
at least one superordinate process control unit for controlling the process, which is in data communication with the multiplicity of field devices in such a way that at least the primary process variable can be communicated between the process control unit and the multiplicity of field devices so that a process running in the automation technology system can be controlled by the process control unit; and
a database and analysis platform in data communication with the multiplicity of field devices in such a way that the acquired environmental variables can be communicated from the multiplicity of field devices to the database and analysis platform and the database and analysis platform is configured to compare the acquired transmitted secondary environmental variables with comparative environmental variables which represent a usual state of the automation system to detect an unusual state in the automation system.
